(19) United States
(12) Patent Application Publication
(10) Pub. No.: US 2005/0122026 A1
(43) Pub. Date: Jun. 9, 2005

(54) Deflection device for a cathode-ray tube

(76) Inventors: Gildo Di Domenico, Colleferro (IT); Paolo Romani, Paliano (IT); Angelo Fiaschetti, Morolo (IT)

Correspondence Address: Joseph S Tripoli;Patent Operations, Thomson Licensing Inc, P O Box 5312, Princeton, NJ, 08543-5312, US

(21) Appl. No.: 10/506,711

(22) PCT Filed: Mar. 4, 2003
(86) PCT No.: PCT/EP03/02201

(30) Foreign Application Priority Data
Mar. 8, 2002 (IT) MI2002A000501

(51) Int. Cl. H01J 29/50; H01J 29/70

(52) U.S. Cl. 313/421; 313/440; 313/413

(57) ABSTRACT

Deflection system for a cathode-ray tube comprising a pair of vertical deflection coils and a pair of horizontal deflection coils, the two pairs being electrically insulated by a separator. The system also comprises auxiliary coils modulating the horizontal scan velocity. The support 9 for the auxiliary coils, made of plastic, comprises openings 32 placed under the location 30 of the said auxiliary coils so as to decrease the relative permittivity of the space between these coils and the neck of the tube, which tends to decrease the occurrence of electric arcs in the neck of the tube when switching it on.

The invention relates to an electron beam deflection system for a cathode-ray tube, and more particularly to a device for modulating the horizontal scan velocity preventing the occurrence of electric arcs when switching on the tube.

An electron beam deflection system for a cathode-ray tube generally consists of a pair of vertical deflection coils and a pair of horizontal deflection coils, the two pairs being electrically insulated by a separator, generally made of plastic, which furthermore makes it possible to improve the mechanical rigidity of the deflection device, to fasten the coils with respect to each other and to adjust the assembly on the neck of the tube. The separator consists of a main body, in one or more parts, substantially in the shape of a funnel, and of a rear part closely following the neck of the tube and designed to fix the position of the deflection position, this fixing generally taking place by means of a clamping collar placed above the flexible rear part.

In order to improve the transitions between a dark part and a bright part of the image formed on the screen during the horizontal scan of the cathode tube screen, it is known to use a pair of auxiliary coils called horizontal scan velocity modulation coils, also called SVM; these coils superimpose an auxiliary field onto the horizontal deflection field created by the main coils, so as to anticipate the considerable variations of the brightness signal and, as a consequence, to modify the velocity of the horizontal scan. It is also known advantageously to place these auxiliary coils on the neck of the tube, the horizontal deflection coils of the deflection system sometimes covering them either partially or completely. It is also known to produce these auxiliary coils by etching on a support in the shape of a rigid or flexible ring. Examples of such arrangements are described in European Patent Application EP484606.

When fixing, on the neck of the tube, a deflection system comprising auxiliary coils for modulating the scan velocity of the electron beams, the position of the said auxiliary coils must be adjusted with respect to the horizontal deflection coils and with respect to the electron gun placed in the neck of the tube so as to optimize their effect on the electron beams. To do this, the SVM can be fitted to the rear of the separator or on an independent support making it possible to separate its position from that of the deflector.

It has however been noticed that the introduction of the SVM would generate an increase in the occurrence of electric arcs in the neck of the tube, particularly when switching it on.

The aim of the present invention is to reduce the occurrence of electric arcs when switching on the tube, in the neck thereof.

In order to achieve this aim, the electron beam deflection system for a cathode-ray tube according to the invention comprises a pair of horizontal deflection coils, a pair of vertical deflection coils and at least one pair of auxiliary coils placed around the neck of the tube, intended to modify the magnetic field created by at least one of the two pairs of deflection coils, the said auxiliary coils being placed on a cylindrical support, characterized in that at least part of the said support located under a pair of auxiliary coils comprises regions with a low relative permittivity.

The invention will be better understood by means of the drawings, among which:

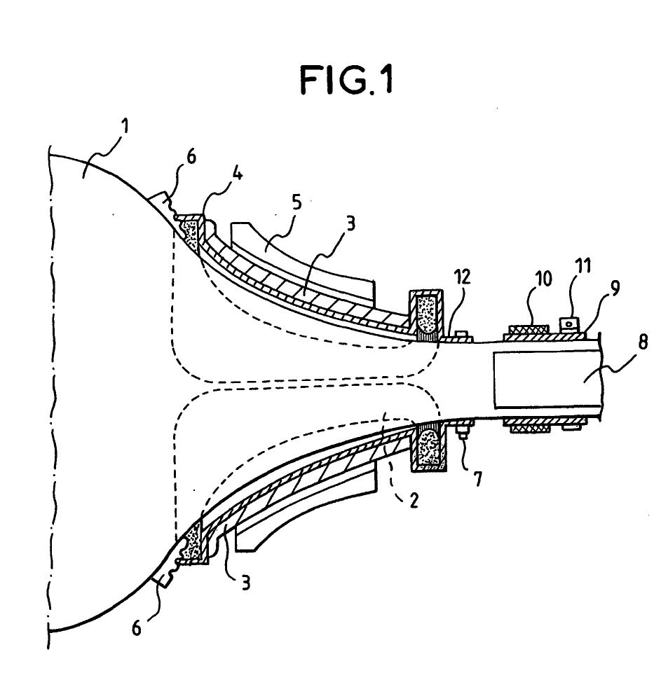

FIG. 1 shows a deflection device according to the present invention,

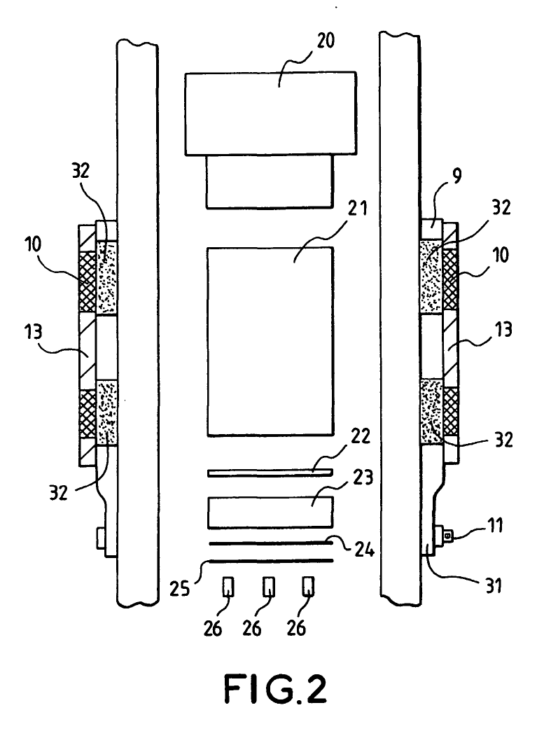

FIG. 2 shows a perspective view of an auxiliary coil support according to the present invention,

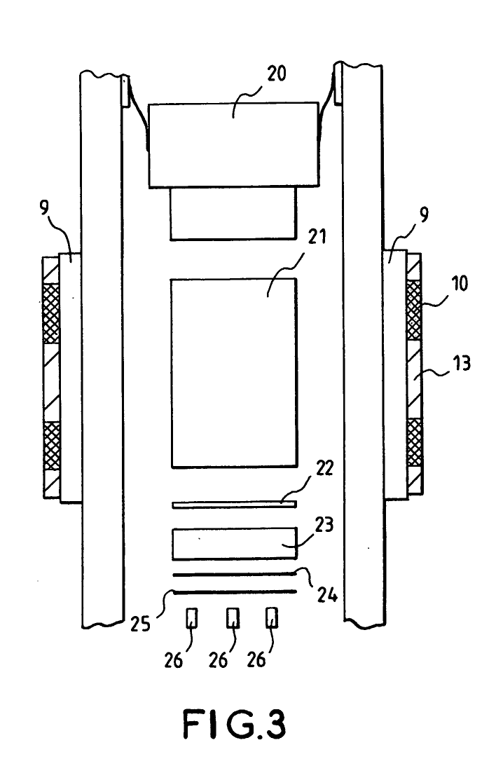

FIG. 3 shows a section through the neck of the tube at the level of the auxiliary coils illustrating an embodiment according to the prior art,

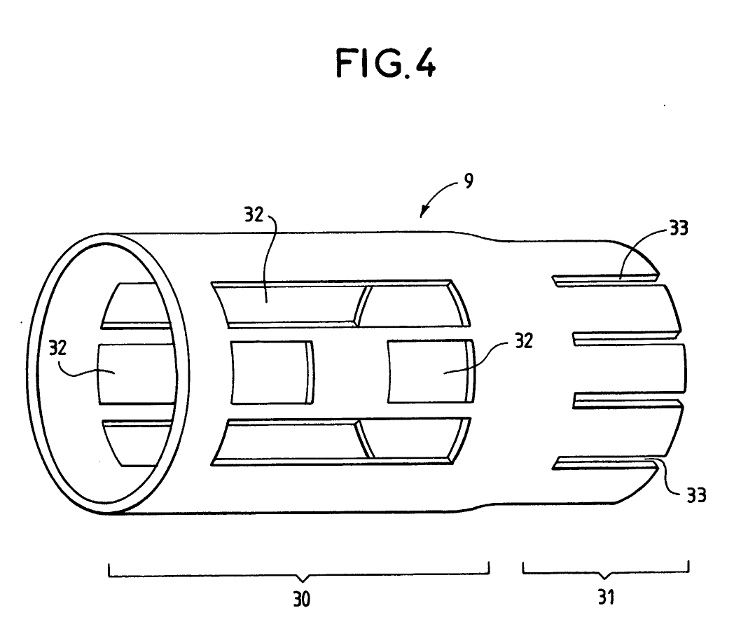

FIG. 4 shows a section through the neck of the tube at the level of the auxiliary coils illustrating an embodiment according to the invention.

As illustrated in FIG. 1, a beam deflection system for a cathode-ray tube 1 comprises a pair of horizontal deflection coils 2 shown in dotted line, and a pair of vertical deflection coils 3. The two pairs of coils are placed on either side of a separator 4, generally made of plastic, having the function of holding one pair of coils in position with respect to the other and of providing the mechanical rigidity of the assembly while at the same time offering electrical insulation between the two pairs of coils; a ring made of a ferromagnetic material 5 surrounds the deflection coils at least partly in order to concentrate their field on the electron beams which they are intended to deflect; the deflection device, as indicated in FIG. 1, furthermore comprises, on its front part, fastening means (6) on the tube while a flexible ring (12) enables its rear part to be fastened to the neck of the tube by virtue of a clamping collar (7).

Within the scope of the invention, the deflection device furthermore comprises a scan velocity modulation device, the SVM, comprising a cylindrical ring 9 serving to support the auxiliary coils 10 intended to create at least one radial magnetic field. The support 9 is held in place on the neck of the tube by a clamping ring 11 placed on a flexible part of the support.

FIG. 3 illustrates an embodiment according to the prior art of a scan velocity modulation system. This system is placed around the neck of the tube 19, at the level of the electron gun 8 consisting of a succession of electrodes 20 to 25 traversed by electron beams from the cathodes 26. The auxiliary coils 10 are in this case etched onto a flexible sheet 13 wound around a support 9 in the form of a cylindrical ring consisting of an insulating material, for example a plastic.

It has been noted that, when switching on the tube, electric arcs occurred in the neck of the tube in the region located at the level of the gun and that the use of auxiliary coils of the SVM would markedly increase the occurrence of these arcs.

Since the SVM coils are raised to the earth potential on switching on the tube, it has been concluded that their presence modifies, by a capacitive effect, the equipotentials in the region between the electrodes of the gun and the neck of the tube and consequently, the distribution of electric charges along the neck, which would promote the appearance of arcs in the said neck.

To decrease this capacitive effect, the invention proposes modifying the relative permittivity of the material acting as a support for the SVM.

However, this modification absolutely must take into account the cost of the material used and the fact that by increasing the thickness of the material, the sensitivity of the electron beams to the fields created by the auxiliary coils is decreased, which would make it necessary to increase the currents supplying the said coils.

The invention is applicable to any type of support material and in particular to plastic, which has the advantages of being a cheap material and of having sufficient mechanical rigidity while offering good properties as an electric insulator.

As illustrated in FIGS. 3 and 4, the plastic support 9 has a cylindrical ring shape and comprises a part 31 around which the flexible film 13, on which the auxiliary coils 10 are etched, is wound; the support 9 furthermore comprises a radially flexible part 31 around which a clamping ring 11 is placed in order to fix the assembly in position on the neck of the tube; the radial flexibility of the part 31 is achieved by virtue of longitudinal notches 33 emerging at one of the ends of the ring 9.

The capacitor created by the support 9 has a capacitance:

C=εᵣε₀S/e where εᵣ is the relative permittivity or dielectric constant of the material forming the support 9.

The regions of low relative permittivity are produced by creating windows 32 in the body of the support ring 9. Since the relative permittivity of air is 5 to 10 times less than that of the majority of plastics, these windows strongly reduce the capacitive effect responsible for the electric arcs in the neck of the tube.

Because of problems of mechanical rigidity of the cylindrical support 9, it may be desirable not to create windows 32 but simply to reduce the thickness of the support in certain regions of its part 30.

It was also noted that a lower occurrence of arcs was obtained if the windows 32 were directly located under the location of the auxiliary coils while extending as much as possible under this location so that their facing surfaces were substantially identical.

The following table shows the influence of the windows on the occurrence of arcs when switching on the tube:

| | | | | With | |
|---|---|---|---|---|---|
| | | With | With | support 9 of | |
| | | support 9 of | support 9 of | 1.2 mm | |
| | Without | thickness | thickness | comprising | |
| SVM type | support 9 | 0.6 mm | 1.2 mm | windows 32 | No SVM |
| Probability of | 2.4 | 0.35 | 0.29 | 0.20 | 0.12 |
| arc occurrence | | | | | |
| on switching on | | | | | |
| the tube | | | | | |

The presence of the windows 32 therefore strongly decreases the occurrence of arcs in the neck of the tube and brings this occurrence to values closer to that occurring in the absence of an SVM.

The auxiliary coils may also be rigid coils made by coiling copper wire, which coils closely follow the shape of the neck of the tube and are held on the support 9 by clipping or adhesive bonding.

The invention is applicable equally to supports integral with the separator of the main deflection coils and to supports independent of the said separator.

1. Electron beam deflection system for a cathode-ray tube comprising a pair of horizontal deflection coils and a pair of vertical deflection coils, these two pairs being electrically insulated from each other by a separator, and at least one pair of auxiliary coils placed around the neck of the tube, intended to modify the magnetic field created by at least one of the two pairs of deflection coils, the said pair of auxiliary coils being placed on a cylindrical support, wherein the part of the said support on which the pair of auxiliary coils is placed comprises regions with a low relative permittivity.

2. Electron beam deflection system according to claim 1, wherein the auxiliary coils are made on a flexible support.

3. Electron beam deflection system according to claim 1, wherein the support for the auxiliary coils is independent of the separator.

4. Electron beam deflection system according to claim 1, wherein the support for the auxiliary coils is made of plastic.

5. Electron beam deflection system according to claim 4, wherein the regions with a low relative permittivity are produced by decreasing the thickness of the support.

6. Cathode-ray tube whose electron beam deflection system complies with claim 1.
